(19) United States
(12) Patent Application Publication
(10) Pub. No.: US 2012/0101840 A1
(43) Pub. Date: Apr. 26, 2012

(54) APPARATUS AND METHOD FOR MEDICATION MANAGEMENT

(76) Inventor: Kyuhyoung CHOI, Seoul (KR)

(21) Appl. No.: 12/981,887

(22) Filed: Dec. 30, 2010

(30) Foreign Application Priority Data
Oct. 26, 2010 (KR) 10-2010-0104741

(51) Int. Cl. G06Q 50/00; G06Q 10/00

(52) U.S. Cl. 705/2

(57) ABSTRACT

The present invention provides an apparatus and a method for a medication management. More particularly, the present invention relates to an apparatus and a method for managing a user's medication by providing an image of medicine prescribed to be taken at a medication time by using prescription information.

### CROSS-REFERENCE TO RELATED APPLICATIONS

This application claims priority to Korean Patent Application No. 10-2010-0104741, filed Oct. 26, 2010, which is herein incorporated by reference in its entirety.

### BACKGROUND OF THE INVENTION

1. Field of the Invention

The present invention relates to an apparatus and a method for a medication management. More particularly, the present invention relates to an apparatus and a method for managing a user's medication by providing an image of medicine prescribed to be taken at a medication time by using prescription information.

2. Description of the Related Art

In order to obtain a proper medication effect, a patient must take prescribed medicine at a proper medication time. However, taking medicine largely tends to rely on the patient's memory. So, in general, it may be difficult for the patient to effectively take a medicine according to a medication schedule, and for a medical institution to check whether or not the patient takes medicine according to prescription Therefore, there is problem in effectively managing the patient's health.

### BRIEF SUMMARY OF THE INVENTION

The problems to be solved by the present invention are as follows.

An aspect of the present invention provides an apparatus and a method for a medication management capable of managing general matters related to medication by using a prescription.

Another aspect of the present invention provides an apparatus and a method for a medication management capable of enabling a user (e.g., a patient) to take a prescribed medicine properly when a medication time arrives.

Another aspect of the present invention provides an apparatus and a method for a medication management capable of providing an image of a prescribed medicine to enable the user to properly take the prescribed medicine.

Another aspect of the present invention provides an apparatus and a method for a medication management capable of providing information on whether or not the user takes a medicine to a medical institution.

The problems are solved by providing an apparatus and a method for a medication management according exemplary embodiments of the present invention as follows.

According to an aspect of the present invention, an apparatus for a medication management comprises: an output module; a communication module configured to communicates with an external device; and a controller configured to obtain prescription information, obtain a medication schedule based on the prescription information, receive, via the communication module, at least one prescribed medicine image corresponding to at least one prescribed medicine which is determined based on the prescription information from a first external device, and control the output module to display the at least one prescribed medicine image when a medication time according to the medication schedule arrives.

According to another aspect of the present invention, an apparatus for a medication management comprises: an output module; a communication module configured to communicates with an external device; and a controller configured to obtain prescription information, obtain a medication schedule based on the prescription information, receive, via the communication module, at least one prescribed medicine image corresponding to at least one prescribed medicine which is determined based on the prescription information from a first external device, and control the output module to display the at least one prescribed medicine image when a medication time according to the medication schedule arrives. Here, the first external device stores a plurality of medicine images, selects the at least one prescribed medicine image corresponding to the at least one prescribed medicine from the plurality of medicine images based on the prescription information, and transmits the selected at least one prescribed medicine image to the apparatus for a medication management.

According to another aspect of the present invention, an apparatus for a medication management comprises: an output module; a communication module configured to communicates with an external device; and a controller configured to obtain prescription information, obtain a medication schedule based on the prescription information, receive, via the communication module, at least one prescribed medicine image corresponding to at least one prescribed medicine which is determined based on the prescription information from a first external device, and control the output module to display the at least one prescribed medicine image when a medication time according to the medication schedule arrives. Here, the controller obtains the prescription information based on at least one of: an electronic prescription which the controller receives via the communication module from the external device; and an image of at least one of a paper prescription or an identification code. Here, when the controller obtains the prescription information based on the image, the apparatus for a medication management further comprise the camera configured to capture the image of at least one of the paper prescription and the identification code, both of which contains the prescription information.

According to another aspect of the present invention, an apparatus for a medication management comprises: an input module; an output module; a communication module configured to communicates with an external device; and a controller configured to obtain prescription information, obtain a medication schedule based on the prescription information, receive, via the communication module, at least one prescribed medicine image corresponding to at least one prescribed medicine which is determined based on the prescription information from a first external device, control the output module to display the at least one prescribed medicine image when a medication time according to the medication schedule arrives, receive, via the input module, a signal for selecting a medicine image from the displayed at least one prescribed medicine image, and determine whether or not a medicine corresponding to the selected medicine image is taken at the medication time based on a signal.

According to another aspect of the present invention, an apparatus for a medication management comprises: an input module; an output module; a communication module configured to communicates with an external device; and a controller configured to obtain prescription information, obtain a medication schedule based on the prescription information, receive, via the communication module, at least one prescribed medicine image corresponding to at least one prescribed medicine which is determined based on the prescription information from a first external device, control the output module to display the at least one prescribed medicine image when a medication time according to the medication schedule arrives, receive, via the input module, a signal for selecting a medicine image from the displayed at least one prescribed medicine image, and determine whether or not a medicine corresponding to the selected medicine image is taken at the medication time based on a signal. Here, the controller transmits the determination result to the first external device and/or stores a medication status on the medication schedule the medication status: indicating whether or not each of the at least one prescribed medicine is taken; and being determined based on the determination result. When the controller stores the medication status, the apparatus for a medication management further comprises the storage unit configured to store the medication status.

According to another aspect of the present invention, an apparatus for a medication management comprises: an input module; an output module; a communication module configured to communicates with an external device; and a controller configured to obtain prescription information, obtain a medication schedule based on the prescription information, receive, via the communication module, at least one prescribed medicine image corresponding to at least one prescribed medicine which is determined based on the prescription information from a first external device, control the output module to display the at least one prescribed medicine image when a medication time according to the medication schedule arrives, receive, via the input module, a signal for selecting a medicine image from the displayed at least one prescribed medicine image, and control the output module to display supplementary information of a medicine corresponding to the selected medicine image.

According to an aspect of the present invention, a method for a medication management performed by an electronic device, comprises: obtaining prescription information; obtaining at least one prescribed medicine and a medication schedule based on the prescription information; transmitting information reflecting the at least one prescribed medicine to a first external device; receiving at least one prescribed medicine image corresponding to the at least one prescribed medicine from the first external device; and when the medication time according to a medication schedule arrives, displaying the at least one prescribed medicine image.

According to another aspect of the present invention, a method for a medication management performed by an electronic device, comprises: receiving an electronic prescription from a second external device; obtaining prescription information based on the electronic prescription, obtaining at least one prescribed medicine and a medication schedule based on the prescription information; transmitting information reflecting the at least one prescribed medicine to a first external device; receiving at least one prescribed medicine image corresponding to the at least one prescribed medicine from the first external device; and when a medication time according to the medication schedule arrives, displaying the at least one prescribed medicine image.

According to another aspect of the present invention, a method for a medication management performed by an electronic device, comprises: obtaining prescription information; obtaining at least one prescribed medicine and a medication schedule based on the prescription information; transmitting information reflecting the at least one prescribed medicine to a first external device; receiving at least one prescribed medicine image corresponding to the at least one prescribed medicine from the first external device; when a medication time according to the medication schedule arrives, displaying the at least one prescribed medicine image; receiving a signal for selecting a medicine image from the displayed at least one prescribed medicine image; and determining whether or not a medicine corresponding to the selected medicine image is taken at the medication time based on a signal.

The present invention has the following advantages.

According to an exemplary embodiment of the present invention, because an image of a prescribed medicine is provided at a medication time, the user can take the prescribed medicine according to the medication time.

According to an exemplary embodiment of the present invention, because information regarding medication is provided when a medication time arrives, the user can appropriately take the prescribed medicine according to a medication schedule.

According to an exemplary embodiment of the present invention, because general matters regarding a medication management are performed by using a prescription, the user can simply get a medication management without having to perform a particular manipulation.

According to an exemplary embodiment of the present invention, because matters related to medication such as whether or not the user takes a medicine are collectively and comprehensively collected and managed, a medical institution is able to effectively and systematically mange the user's health.

According to an exemplary embodiment of the present invention, because detailed information regarding a prescribed medicine is provided, the user can take a medicine upon checking it, and accordingly, a medication effect and medication adaptation can be increased.

According to an exemplary embodiment of the present invention, because the user can get an effective medication management, he can lead a healthier life and unnecessary medical expenses can be saved in terms of society.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of an apparatus for a medication management according to an exemplary embodiment of the present invention.

FIG. 2 is a schematic block diagram of the apparatus for a medication management according to an exemplary embodiment of the present invention.

FIG. 3 is a view illustrating a system for a medication management according to an exemplary embodiment of the present invention.

FIG. 4 is a flow chart illustrating the process of a method for a medication management according to a first exemplary embodiment of the present invention.

FIG. 5 is a view illustrating a paper prescription in the method for a medication management according to the first exemplary embodiment of the present invention.

FIG. 6 is a view illustrating an identification code in the method for a medication management according to the first exemplary embodiment of the present invention.

FIG. 7 is a view illustrating an output of a prescribed medicine image in the method for a medication management according to the first exemplary embodiment of the present invention.

FIG. 8 is a flow chart illustrating the process of a method for a medication management according to a second exemplary embodiment of the present invention.

FIG. 9 is a view illustrating an output of information for a medication management of the method for a medication management according to the second exemplary embodiment of the present invention.

FIG. 10 is a first view illustrating an input of a signal regarding whether or not a prescribed medicine is taken in the method for a medication management according to the second exemplary embodiment of the present invention.

FIG. 11 is a second view illustrating an input of a signal regarding whether or not a prescribed medicine is taken in the method for a medication management according to the second exemplary embodiment of the present invention.

FIG. 12 is a flow chart illustrating the process of a method for a medication management according to a third exemplary embodiment of the present invention.

FIG. 13 is a view illustrating displaying of supplementary information in the method for a medication management according to the third exemplary embodiment of the present invention.

FIG. 14 is a view illustrating a medication status in the method for a medication management according to the third exemplary embodiment of the present invention.

### DETAILED DESCRIPTION OF THE INVENTION

The terminology used herein is for the purpose of describing particular embodiments only and is not intended to be limiting of the invention.

The present invention may be embodied in many different forms and may have various embodiments, of which particular ones will be illustrated in drawings and will be described in detail. However, it should be understood that the following exemplifying description of the invention is not meant to restrict the invention to specific forms of the present invention but rather the present invention is meant to cover all modifications, similarities and alternatives which are included in the spirit and scope of the present invention.

The same reference numerals will be used throughout to designate the same or like components, and a repeated description may be omitted.

The present invention is not limited to the exemplary embodiments described hereinafter.

Exemplary embodiments of the present invention will now be described with reference to the accompanying drawings.

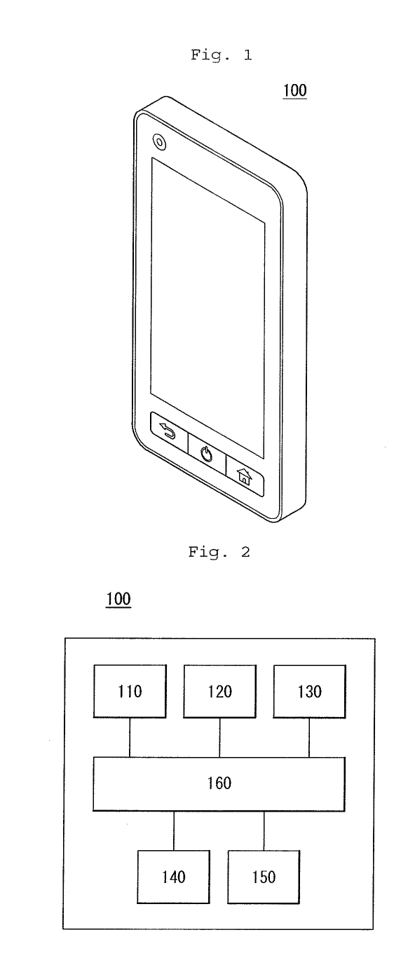

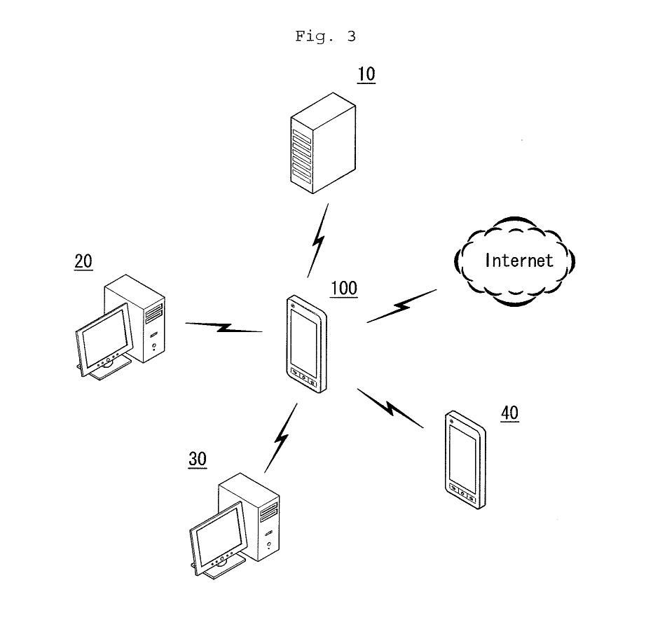

An apparatus for a medication management according to an exemplary embodiment of the present invention will now be described with reference to FIGS. 1 and 2. FIG. 1 is a perspective view of an apparatus for a medication management according to an exemplary embodiment of the present invention and FIG. 2 is a schematic block diagram of the apparatus for a medication management according to an exemplary embodiment of the present invention.

The apparatus 100 for a medication management may manage general matters in relation to taking medicines, namely, medication.

The apparatus 100 for a medication management may analyze and obtain information required for medication by using a prescription, or the like. In addition, the apparatus 100 for a medication management may provide an image of a prescribed medicine to a user by using the analyzed information to allow the user to properly take a medicine. In addition, the apparatus 100 for a medication management may provide information regarding medication when a medication time arrives, so that the user can take a medicine at a proper time. In addition, the apparatus 100 for a medication management may determine whether or not the user takes a medicine, and manage comprehensive information regarding the user's medication situation based on the determination. In addition, the apparatus 100 for a medication management may provide various types of supplementary information of a prescribed medicine. Accordingly, the user may get a medication management with respect to general matters from a point in time when he is prescribed by the doctor to a point in time of medication.

As shown in FIGS. 1 and 2, the apparatus 100 for a medication management may comprises at least one of an input module 110 receiving various types of information for a medication management, an output module 120 outputting various types of information for a medication management, a communication module 130 communicating with an external device to transmit and receive various types of information for a medication management, a storage unit 150 storing various types of information for a medication management, a camera 140 capturing an image of a paper prescription or an identification code containing prescription information, and a controller 160 controlling each element to obtain the prescription information and output a prescribed medicine image at a medication time by using the obtained prescription information.

The apparatus 100 for a medication management may not necessarily comprise the foregoing elements but may selectively comprise the foregoing elements.

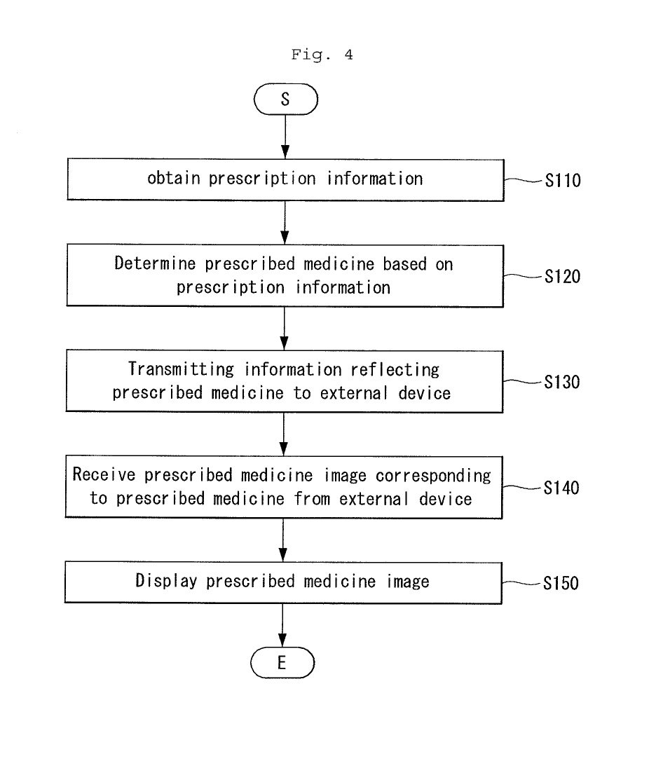

Hereinafter, the elements of the apparatus 100 for a medication management will be described in order of the communication module 130, the camera 140, the output module 120, the input module 110, the storage unit 150, and the controller 160. FIG. 3 is a view illustrating a system for a medication management according to an exemplary embodiment of the present invention.

The communication module 130 may perform communication with an external device. Here, as shown in FIG. 3, the external device may include a medication management server 10, a hospital device 20, a drug store device 10, a mobile communication terminal 40, a personal computer, an Internet site, and the like. The communication module 130 may perform communication with various external devices through wired/wireless network in various manners. For example, the communication module 130 may perform wireline communication such as a universal serial bus (USB), an RS-232 scheme, and the like. For another example, the communication module 140 may perform wireless communication such as Wi-Fi, WiBro, Bluetooth™, ZigBee™, RFID, IrDA, and the like. The method according to which the communication module 140 performs communication is not limited to the foregoing examples but may include various other methods of transmitting and receiving information to and from an external device.

The communication module 130 may perform communication with the external devices to transmit and receive various types of information for a medication management.

For example, the communication module 130 may receive an electronic prescription from the medication management server 10, the hospital device 20, or the like. The apparatus 100 for a medication management may analyze the received electronic prescription to obtain prescription information (to be described). Here, the prescription information may be information regarding the doctor's diagnosis for a patient, including information regarding the doctor who performs prescription and a patient who is prescribed and information regarding a prescribed medicine, the directions of the medicine, and the like. In the present exemplary embodiment, the controller 160 may determine a prescribed medicine by using the prescription information and generate a medication schedule.

In another example, the communication module 130 may transmit information regarding the prescribed medicine to the medication management server 10, or the like, and the medication management server 10 may transmit a prescribed medicine image of the prescribed medicine based on the received information, and the communication module 130 may receive such a prescribed medicine image.

In still another example, the communication module 130 may transmit information regarding whether or not a user (or a patient) takes the medicine, to the medication management server 10, or the like.

The camera 140 may capture an image of an object reflecting the prescription information. The object reflecting the prescription information may include, for example, an electronic prescription including prescription information, a paper prescription including prescription information, an identification code containing prescription information, and the like. Here, the identification code may include a one-dimensional barcode, a two-dimensional barcode, a quick response (QR) code, and the like, and such an identification code may contain prescription information in conformity with a predetermined coding rule.

The output module 120 may output information to the exterior. Accordingly, the user is able to receive the information from the apparatus 100 for a medication management. The output module 120 may output the information in various manners. The output module 120 may output the information by using a visual signal, a visual signal, an audible signal, and a tactile (or haptic) signal. The output module 120 may include a display, a touch screen, a speaker, a vibrator, and at least one of various other output devices.

The output module 120 may provide various types of information. For example, the output module 120 may display a prescribed medicine image of the prescribed medicine or display supplementary information of the prescribed medicine.

The input module 110 may receive information from an external source. The input module 110 may receive the information according to various methods. The input module 110 may receive the information according to a signal generated as a keyboard is pressed, a touch signal, a gesture signal, a voice signal, an image signal, and the like. The input module 110 may include a keyboard, a mouse, a touch screen, a microphone, and at least one of various other input devices.

The input module 110 may receive various types of information or signals. For example, the input module 110 may receive a touch signal for selecting a prescribed medicine image through a touch screen. In the present exemplary embodiment, whether or not the user takes a medicine may be determined based on a signal of touching the prescribed medicine image (to be described).

The storage unit 150 may store information. The storage unit 150 may include various storage mediums. For example, the storage unit 150 may include a flash memory, a RAM, a ROM, a hard disk, an SD card, an optical disk such as a CD or a Blu-ray disk, and various other storage mediums. The storage unit 150 may be installed within the apparatus 100 for a medication management or may be configured to be detachably mounted in the apparatus 100 for a medication management.

The storage unit 150 may store information related to a medication management. The storage unit 150 may receive information from the communication module 130, the camera 140, the input module 110, the controller 160, and the like, and store the received information. The information related to the medication management may include an electronic prescription, an image of an object containing prescription information, prescription information, information regarding a prescribed medicine, a medication time, a medication schedule, whether or not the user takes a medicine, a medication status regarding whether or not the user takes a medicine according to a medication schedule, various types of supplementary information of a medicine, and the like.

The controller 160 may control a different element of the apparatus 100 for a medication management. For example, the controller 160 may obtain a prescription from the communication module 130 or the camera 140 and analyze to obtain prescription information. In another example, the controller 160 may generate a medication schedule by using the prescription information and control the output module 120 to output an image of a prescribed medicine prescribed to be taken at a medication time according to a medication schedule. The controller 160 may include a microprocessor. Details of the controller 160 will be described in explaining a method for a medication management according to an exemplary embodiment of the present invention.

A method for a medication management according to an exemplary embodiment of the present invention will now be described.

The method for a medication management according to an exemplary embodiment of the present invention will be described by using the apparatus 100 for a medication management. Here, the apparatus 100 for a medication management is used to easily explain the method for a medication management according to an exemplary embodiment of the present invention. Thus, the method for a medication management according to an exemplary embodiment of the present invention is not limited by the apparatus 100 for a medication management according to an exemplary embodiment of the present invention.

The method for a medication management according to an exemplary embodiment of the present invention may be performed by using a different apparatus that performs the same function as that of the apparatus 10 for a medication management according to an exemplary embodiment of the present invention.

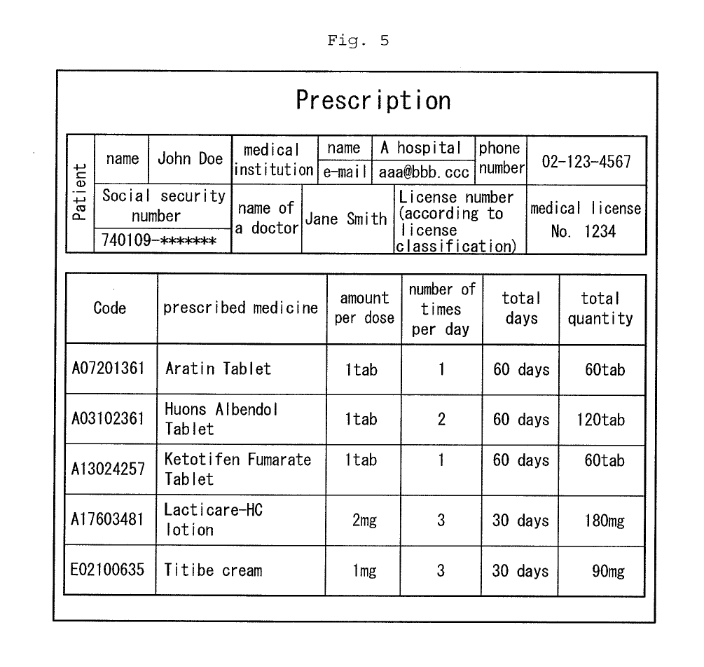

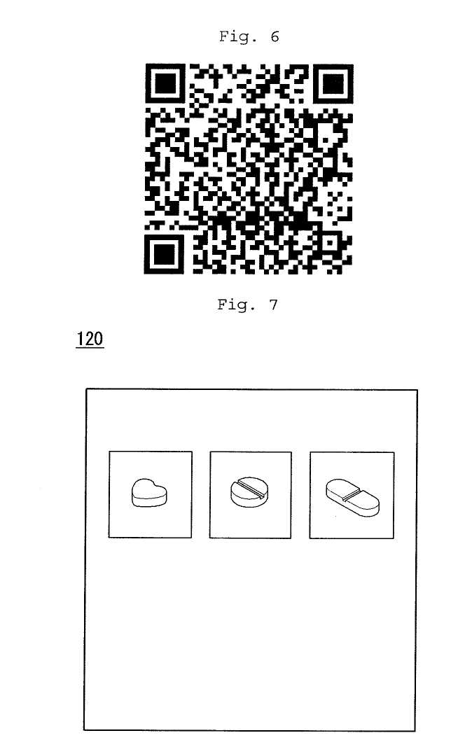

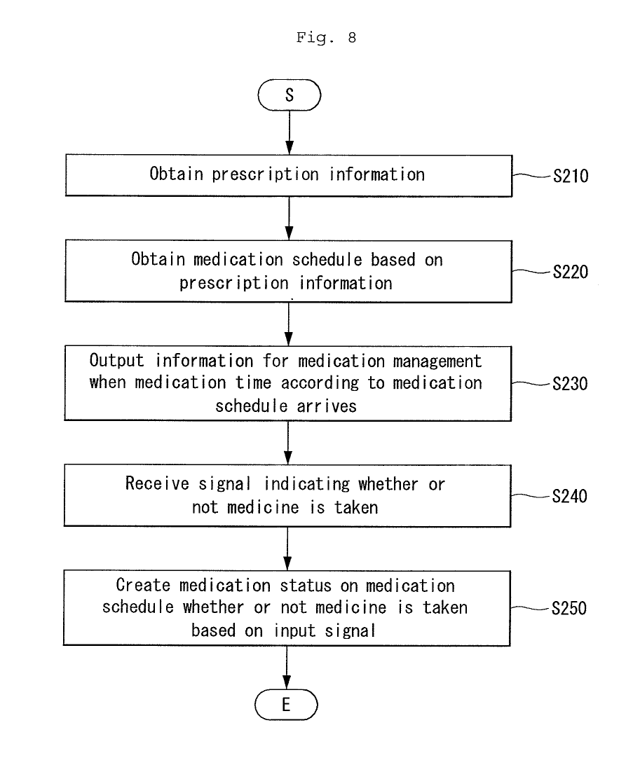

Hereinafter, the method for a medication management according to a first exemplary embodiment of the present invention will now be described with reference to FIGS. 4 to 7. FIG. 4 is a flow chart illustrating the process of a method for a medication management according to a first exemplary embodiment of the present invention. FIG. 5 is a view illustrating a paper prescription in the method for a medication management according to the first exemplary embodiment of the present invention. FIG. 6 is a view illustrating an identification code in the method for a medication management according to the first exemplary embodiment of the present invention. FIG. 7 is a view illustrating an output of a prescribed medicine image in the method for a medication management according to the first exemplary embodiment of the present invention.

As shown in FIG. 4, the method for a medication management according to the first exemplary embodiment of the present invention may comprise at least one of a step (S110) of obtaining prescription information, a step (S120) of determining a prescribed medicine based on the prescription information, a step (S130) of transmitting information reflecting the prescribed medicine to an external device, a step (S140) of receiving a prescribed medicine image corresponding to the prescribed medicine from the external device, and a step (S150) of displaying the prescribed medicine image. The respective steps of the method for a medication management according to the first exemplary embodiment of the present invention will now be described.

The apparatus 100 for a medication management may obtain prescription information (S110).

The controller 160 may obtain prescription information. Here, the prescription information may include information for determining a medicine prescribed by the doctor for a patient, namely, a prescribed medicine. Here, the doctor may have a broad concept including medical parties who may substitute the doctor, e.g., veterinarian, a health manager, and so on, as well as a general doctor, and the patient may not indicate only a person suffering from a disease but a person who is prescribed, having a broad concept including even animals.

The controller 160 may obtain such prescription information in various manners.

First, the controller 160 may obtain the prescription information via the communication module 130. The communication module 130 may receive the prescription information from the hospital device 20 or the medication management server 10. Here, the medication management server 10 may be a server that collects, manages, processes, and provides general information related to a medication management. For example, the medication management server 10 may receive the prescription information from the hospital device 20 or from the doctor, store the received prescription information, and provide the stored prescription information to the apparatus 100 for a medication management via the communication module 130.

Second, the controller 160 may analyze an image of an object implying the prescription information to obtain the prescription information. Here, the object including the prescription information may be various. The object may include a paper prescription or an identification code containing the prescription information. In this case, the identification code may have a shape in which the prescription information is contained according to a predetermined coding rule. For example, the identification code may include a one-dimensional code, a two-dimensional barcode, a quick response (QR) code, and the like. In the present exemplary embodiment, the camera 140 may capture an image of the object including the prescription information, and the controller 140 may analyze the captured image of the object to obtain the prescription information.

For example, the camera 140 may capture the image of the paper prescription created by the doctor. Here, the prescription may include a document including the doctor's diagnosis for a patient upon treating the patient. The prescription may include information regarding the doctor who has prescribed, the patient who was prescribed, a prescription time, a prescription hospital, a prescribed medicine, the directions of the prescribed medicine, a note of caution with respect to the prescribed medicine, and the like. In general, the paper prescription may include a document in which the doctor has taken note of the foregoing content, or a document output through a printing machine, such as a printer, as shown in FIG. 5.

Here, the camera 140 may capture an image of the paper prescription to obtain the captured image of the paper prescription, and the controller 160 may analyze the image of the paper prescription to obtain the prescription information. In this case, the controller 160 may recognize a printed document or the characters written by the doctor through a character recognition algorithm. In detail, as shown in FIG. 5, the prescription may include the names of medicines, codes assigned to the medicines, and the like. The controller 160 may recognize the characters indicating the names of the medicines or the codes assigned to the medicines to obtain the prescription information including information regarding the prescribed medicines.

In another example, the camera 140 may capture an image of an identification code containing prescription information. The identification code is a code encrypted according to a predetermined rule, and here, the identification code may be provided as a figure, a symbol, a character, and the like, obtained by encrypting the prescription information. The identification code may have a barcode form. In detail, the identification code may include a one-dimensional barcode, a two-dimensional barcode, and the like. Here, as shown in FIG. 6, the two-dimensional barcode may be a matrix code, a QR code, and the like, which may reflect the encrypted prescription information by a figure, a symbol, a character, and the like prepared on two-dimensional plane. The two-dimensional barcode advantageously stores more information compared to a one-dimensional barcode. The camera 140 may capture an image of the identification code to obtain the captured image, and the controller 160 may decrypt the image of the identification code according to a decryption method of each identification code, thus obtaining the prescription information contained in the identification code.

Third, the controller 160 may obtain an electronic prescription via the communication module 130 and analyze the obtained electronic prescription to obtain prescription information. Here, unlike the prescription written on paper, the electronic prescription may refer to a prescription prepared in the form of electronic information. The electronic prescription is advantageous in that it can easily bear more information compared with the existing paper prescription and may be exchanged through a communication network, without having to use or retain paper. The controller 160 may receive an electronic prescription from the hospital device 20 or the medication management server 10 via the communication module 130 and extract information regarding a prescribed medicine from the received electronic prescription.

Meanwhile, the prescription includes information regarding a person. In case of the electronic prescription, because it has a high possibility of being leaked, the security of the electronic prescription may be important. Thus, the electronic prescription may be encrypted according to a predetermined method. The encrypted prescription information may be decrypted when it is authenticated through a determined authentication procedure. In this case, the controller 160 may decrypt the encrypted electronic prescription obtained from the communication module 130 and extract the prescription information from the decrypted electronic prescription. For example, in the apparatus 100 for a medication management, the user's fingerprint may be received through a touch screen or an image of the user's pupil may be captured, and the controller 160 may compare the same with authentication information stored in the storage unit 150 and allow the electronic prescription to be used only when the user is successfully authenticated.

Fourth, the input module 110 may receive prescription information from the user, and the controller 160 may obtain the prescription information via the input module 110. The input method may include a touch input through the touch screen, an input through a keyboard, a voice input through a microphone, and the like.

Fourth, the controller 160 may obtain prescription information from an object containing prescription information via the communication module 130. Here, the object containing the prescription information may include an object that is able to transmit the prescription information to the communication module 130 through short-range communication. In detail, the object may include a radio frequency identification (RFID) tag storing the prescription information, and the like.

The apparatus 100 for a medication management may determine a prescribed medicine based on the prescription information (S120).

The controller 160 may determine a prescribed medicine by using the obtained prescription information. The obtained prescription information may include information regarding the prescribed medicine, and the controller 160 may determine what kind of medicine it is by using the prescription information. In detail, the prescription information may include the name of a medicine, a medicine code corresponding to a medicine, and the like, and the controller 160 may determine the prescribed medicine by using at least one of the name of the medicine and the medicine code. Here, the name of the medicine or the medicine code may follow a determined medical standard, and the storage unit 150 may include a database regarding the name of the medicine or the medicine code in conformity with the standard. The controller 160 may determine a medicine by utilizing such a database.

The apparatus 100 for a medication management may transmit information reflecting the prescribed medicine to an external device (S130).

The communication module 130 may transmit the information reflecting the prescribed medicine to an external device. The controller 160 may transmit the information reflecting the prescribed medicine to an external device via the communication module 130. Here, the external device may include the medication management server 10.

Meanwhile, the external device may receive information reflecting the electronic prescription, the prescription information, or the prescribed medicine directly from a different device, e.g., the hospital device 20, rather than the apparatus 100 for a medication management. In this case, the external device may not receive the information reflecting the prescribed medicine. In this case, however, because the prescription information is personal information, when the external device directly receives the prescription information from the hospital, or the like, a procedure for getting the patient's consent will be required.

Here, the external device, e.g., the medication management server 10 may store medicine images regarding a plurality of medicines. As discussed above, the external device may obtain the information regarding the prescribed medicine, the prescription information, or the electronic prescription, determine the prescribed medicine based on the same, select a prescribed medicine image corresponding to the prescribed medicine from among the stored medicine images of the plurality of medicines, and transmit the selected prescribed medicine image to the apparatus 100 for a medication management.

The apparatus 100 for a medication management may receive the prescribed medicine image corresponding to the prescribed medicine from the external device (S140).

The communication module 130 may receive the prescribed medicine image corresponding to the prescribed medicine from the external device, e.g., the medication management server 10. The prescribed medicine image may not necessarily refer to only the image of the prescribed medicine itself. In other words, the prescribed medicine image may be an image from which the prescribed medicine can be recognized. The prescribed medicine image may include, for example, an image of the prescribed medicine itself, an image of a package or a container accommodating the medicine, or the like.

The apparatus 100 for a medication management may display the prescribed medicine image (S150).

The output module 120 may display the prescribed medicine image. The controller 160 may control the output module 120 to display the prescribed medicine image. For example, as shown in FIG. 7, the controller 160 may control the output module 120 to display the prescribed medicine image. Here, in case of one or more prescribed medicines, the output module 120 may display an image of each medicine.

The method for a medication management according to the first exemplary embodiment of the present invention has the effect that because the apparatus 100 for a medication management obtains the prescription information and displays the prescribed medicine image by using the obtained prescription information, the user can check the prescribed medicine and take it properly.

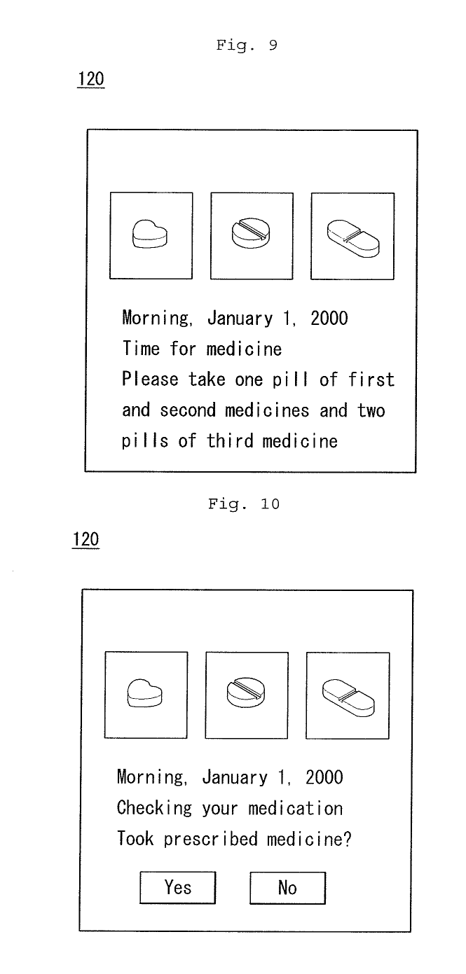

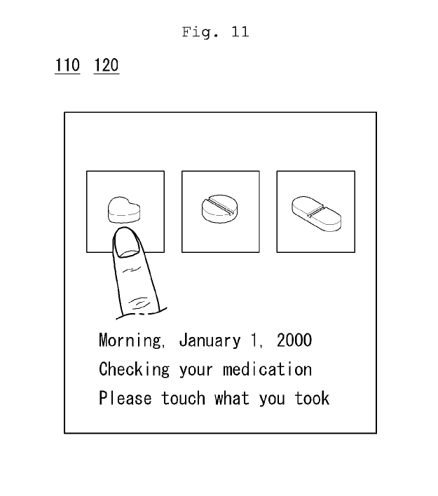

Hereinafter, a method for a medication management according to a second exemplary embodiment of the present invention will be described with reference to FIGS. 8 to 11. FIG. 8 is a flow chart illustrating the process of a method for a medication management according to a second exemplary embodiment of the present invention. FIG. 9 is a view illustrating an output of information for a medication management of the method for a medication management according to the second exemplary embodiment of the present invention. FIG. 10 is a first view illustrating an input of a signal regarding whether or not a prescribed medicine is taken in the method for a medication management according to the second exemplary embodiment of the present invention. FIG. 11 is a second view illustrating an input of a signal regarding whether or not a prescribed medicine is taken in the method for a medication management according to the second exemplary embodiment of the present invention.

As shown in FIG. 8, the method for a medication management according to the second exemplary embodiment may comprise at least one of a step (S210) of obtaining prescription information, a step (S220) of obtaining a medication schedule based on the obtained prescription information, a step (S230) of outputting information for a medication management when a medication time according to the medication schedule arrives, a step (S240) of receiving a signal indicating whether or not a user takes a prescribed medicine, and a step (S250) of creating a medication status indicating whether or not the user takes the medicine based on the received signal. Hereinafter, the respective steps of the method for a medication management according to the second exemplary embodiment of the present invention will now be described.

The apparatus 100 for a medication management may obtain prescription information (S210). This may be the same as the content described in the method for a medication management according to the first exemplary embodiment of the present invention. In this case, the prescription information may include information regarding a prescribed medicine. In detail, the prescription information may include information such as the name or type of a medicine or a medicine code, and information regarding the directions of the medicine, e.g., a medication time such as to be taken one time a day, and the like.

The apparatus 100 for a medication management may obtain a medication schedule based on the prescription information (S220). Here, the medication schedule may refer to a schedule regarding a time at which the prescribed medicine is to be taken. The controller 160 may generate the medication schedule by using the prescription information. The controller 160 may generate the medication schedule based on the directions of the prescribed medicine included in the prescription information. For example, in case of a prescribed medicine to be taken two times a day, the controller 160 may generate a medication schedule including medication time determined to be 10:00 a.m. and 6:00 p.m. every day.

The controller 160 may generate a medication schedule by further utilizing information regarding the user. Here, the information regarding the user may include a user's biometric information, information regarding a user's lifestyle, and the like. For example, the user's lifestyle may include information that the user has a breakfast at 9:00 a.m., a lunch at 13:00 p.m., and a dinner at 18:00. The communication module 130 may receive such information regarding the user from an external device, e.g., the medication management server 10, or the like, and the controller 160 may collect the prescription information and the information regarding the user to generate a medication schedule. When the controller 160 obtains the information regarding the user including the information regarding the user's lifestyle and the prescription information including content of the prescription for taking three times a day as described above, the controller 160 may be able to generate a medication schedule including medication time determined to be 10:00, 14:00, and 19:00, each after one hour from the meal time, on the basis of the user information and the prescription information.

When the medication time according to the medication schedule arrives, the apparatus 100 for a medication management may output the information for a medication management (S230). When the medication time according to the medication schedule arrives, the controller 160 may output the information for a medication management. The controller 160 may determine whether or not the medication time according to the medication schedule obtained as described above arrives, and when the medication time arrives, the controller 160 may output the information for a medication management. Here, the information for a medication management may be various. For example, the output module 120 may output a medication notification message indicating that the medication time has arrived. The medication notification message may be displayed on a display or may be output in the form of a voice signal or a vibration signal.

In another example, as shown in FIG. 9, the output module 120 may output a message instructing taking a medicine, information regarding a medication time, and an image of a prescribed medicine prescribed to be taken at the medication time. Here, the prescribed medicine may be different for each medication time, and in this case, the controller may control the output module 120 to output a medicine prescribed to be taken at a corresponding medication time in consideration of the prescription information. In detail, in a state in which first to third medicines are prescribed for the user and, in this case, when the first to third medicines at a first medication time and the first and second medicines at a second medication time, when the first medication time arrives, the controller 160 may control the output module 120 to output the images of the first to third medicines when the first medication time arrives, and display the images of the first and second medicines when the second medication time arrives.

The apparatus 100 for a medication management may receive a signal indicating whether or not the user takes the prescribed medicines (S240). The input module 110 may receive a signal reflecting whether or not the user takes the prescribed medicines. The controller 160 may determine whether or not the prescribed medicines are taken according to the received signal. The input module 110 may receive the signal indicating whether or not the user takes the prescribed medicines in various manners.

For example, as shown in FIG. 10, the input module 110 and the output module 120 may be provided as a touch screen, and the output module 120 may output a message questioning whether or not the user takes the medicines, and the input module 110 may receive a response to the question from the user. The controller 160 may be able to determine whether or not the user takes the medicines based on the received response.

In another example, as shown in FIG. 11, the input module 110 and the output module 120 may be provided as a touch screen, and the output module 120 may output images of the prescribed medicines to be taken at a corresponding medication time when the medication time arrives. Here, the input module 110 may receive a signal that touches the displayed images of the prescribed medicines. The controller 160 may be able to determine that a prescribed medicine, for which a touch signal is received, as a medicine which is taken by the user, based on the touch signal.

Information as to whether or not the user takes the medicines according to the medication schedule may be stored according to an input signal (S250). The controller 160 may determine whether or not the user takes the medicines based on the signal reflecting whether or not the user takes the medicines obtained from the input module 110, and store information regarding whether or not the user takes the medicines at the corresponding medication time according to the determination results. Here, a medication status, i.e., information regarding whether or not the user takes the medicines at each medication time according to the medication schedule, may be stored in the storage unit 150. The controller 160 may generate, alter, or create such a medication status according to the results obtained by determining whether or not the user takes the medicines at the corresponding medication time.

The controller 160 may control the output module 120 to output the medication status according to a user request. The user may receive the medication status and recognize whether or not he is taking medicines properly according to the medication schedule.

In addition, the controller 160 may transmit the information indicating whether or not the user takes the medicines to the external device, e.g., the medication management server 10, or the like. The medication management server 10 may receive the information indicating whether or not the user takes the medicines and create the medication status according to the medication schedule based on the received information, or analyze the information indicating whether or not the user takes the medicines and generate information such as a medication adaptation, and the like. The medication management server 10 may provide such information to the user or to the medical parties so that the medical activity can be more systematically conducted. For example, when the user stops taking the medicines or when the medication adaptation is reduced to below a certain level according to the medication status, the medication management server 10 may output a warning message indicating that the user should take the medicines (i.e., indicating that medicines are not taken consecutively) to the user. In another example, when the user continuously takes the medicines and the medication adaptation is high, the medication management server 10 may output an encouragement message motivating the user to take the medicines to the user.

The method for a medication management according to the second exemplary embodiment has the effect that because the medication is guide at every medication time according to the medication schedule based on the prescription information, the user can properly take a medicine at a medication time. In addition, because the image of a medicine prescribed to be taken is provided at every medication period, the user can check the prescribed medicine and effectively take it. In addition, because the user simply inputs a signal indicating that he takes the medicine and gets a systematic management regarding the medication, the user can continuously get the medication management. Thus, the user can continuously take a medicine and his medication adaptation can be improved.

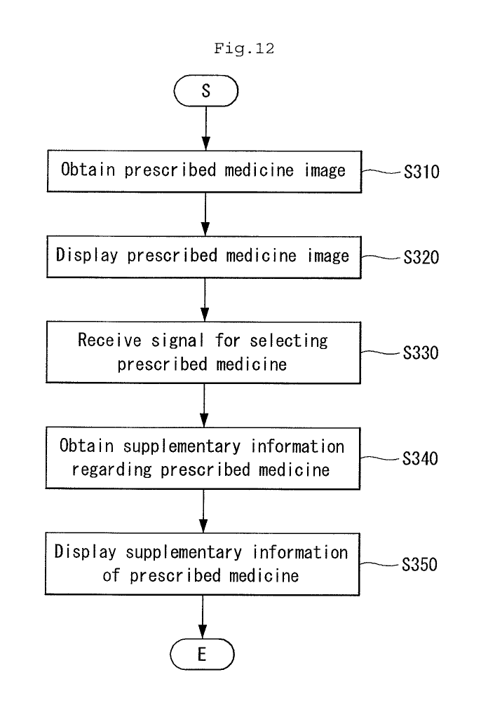

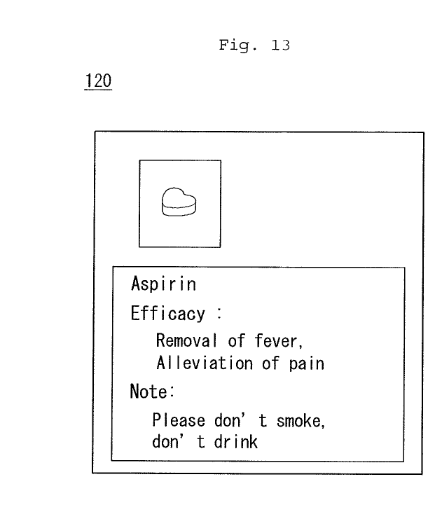

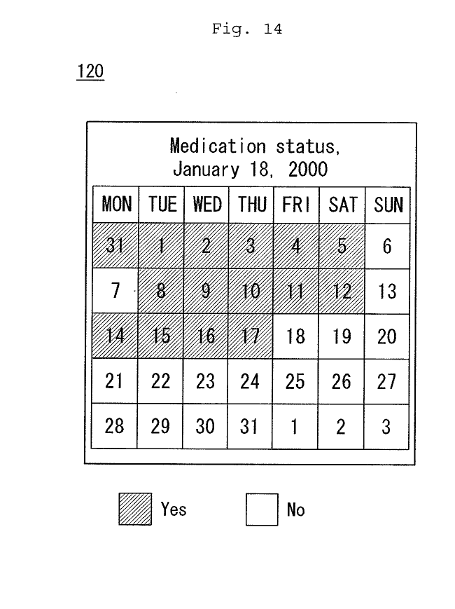

Hereinafter, a method for a medication management according to a third exemplary embodiment of the present invention will be described with reference to FIGS. 12 to 14. FIG. 12 is a flow chart illustrating the process of a method for a medication management according to a third exemplary embodiment of the present invention. FIG. 13 is a view illustrating displaying of supplementary information in the method for a medication management according to the third exemplary embodiment of the present invention. FIG. 14 is a view illustrating a medication status in the method for a medication management according to the third exemplary embodiment of the present invention.

As shown in FIG. 12, the method for a medication management according to the third exemplary embodiment may comprise at least one of a step (S310) of obtaining a prescribed medicine image, a step (S320) of displaying the prescribed medicine image, a step (S330) of receiving a signal for selecting a prescribed medicine, a step (S340) of obtaining supplementary information of the prescribed medicine, and a step (S350) of outputting the supplementary information of the prescribed medicine.

The apparatus 100 for a medication management may obtain a prescribed medicine image (S310). The communication module 130 may receive the prescribed medicine image from the medication management server 10, and the like. Also, the storage unit 150 may store the prescribed medicine image. The controller 160 may obtain the prescribed medicine image via the communication module 130 or obtain the prescribed medicine image from the storage unit 150.

The apparatus 100 for a medication management may display the prescribed medicine image (S320). As described above in the method for a medication management according to the first exemplary embodiment of the present invention, the output module 120 may display the prescribed medicine image. In this case, when there are a plurality of prescribed medicines, the output module 120 may display the plurality of prescribed medicine images.

The apparatus 100 for a medication management may receive a signal for selecting a prescribed medicine (S330). The input module 110 may receive a signal for selecting a prescribed medicine. For example, the input module 110 and the output module 120 may be prepared as a touch screen, and the touch screen may display the prescribed medication image and receive a signal that touches the prescribed medicine image. Here, when there are a plurality of prescribed medicines, the touch screen may display a plurality of prescribed medicine images and receive a signal that touches one of them.

The apparatus 100 for a medication management may obtain supplementary information of the prescribed medicine (S340). The communication module 130 may receive the supplementary information of the prescribed medicine from an external device, e.g., the medication management server 10. In detail, the communication module 130 may transmit information regarding the prescribed medicine to the external device according to a signal from the input module 110, and receive the supplementary information of the prescribed medicine from the external device. Here, the supplementary information of the medicine may include at least one of the name, kind, effect, efficacy, the directions, price, period of circulation, subject disease, note of caution, medicine prevented to be taken in conjunction, and food prevented to be taken in conjunction.

The apparatus 100 for a medication management may output the supplementary information of the prescribed medicine (S350). The output module 120 may output the supplementary information of the prescribed medicine. The controller 160 may control the output module 120 to display the supplementary information obtained from the exterior via the communication module 130. For example, as shown in FIG. 13, the output module 120 may display the information regarding image, name, efficacy, directions, and food prevented to be taken in conjunction of the selected prescribed medicine.

Here, the controller 160 may output the supplementary information of the medicine obtained from the communication module 130 as it is. Alternatively, the controller 160 may process the supplementary information by using the user's physical information and output the same. For example, when the user has a physical constitution that he cannot take a particular medicine, the controller 160 may control the output module 120 to additionally display the corresponding matter. Also, when the user is taken a medicine which cannot be taken in conjunction with the corresponding prescribed medicine, the controller 160 may additionally output a message warning of it. Here, the user's physical information may include information regarding the user's name, gender, age, height, weight, medical history, blood sugar level, blood pressure level, the user's other physical condition, and the like. These types of information may be stored in the storage unit 150 or the communication module 130 may obtain such information from an external device, e.g., the medication management server 10, the hospital device 20, an Internet size, and the like.

Meanwhile, as shown in FIG. 14, the controller 160 may control the output module 120 to display the medication status regarding the selected prescribed medicine.

The method for a medication management according to the third exemplary embodiment of the present invention has the effect that because the apparatus 100 for a medication management provides the image of the prescribed medicine and the supplementary information thereof as well, the user can check the medicine and obtain various types of information required for taking the medicine, allowing the user to effectively take the medicine.

The methods for a medication management according to the respective exemplary embodiments of the present invention can be used alone or may be combined to be used.

According to the exemplary embodiments of the present invention, the individuals can lead a healthy life, and a waste of socially unnecessary medical expenses can be reduced.

The preferred embodiments of the present invention have been described with reference to the accompanying drawings, and it will be apparent to those skilled in the art that various modifications and variations can be made in the present invention without departing from the scope of the invention. Thus, it is intended that any future modifications of the embodiments of the present invention will come within the scope of the appended claims and their equivalents.

What is claimed is:

1. An apparatus for medication management, the apparatus comprising:
an output module;
a communication module; and
a controller configured to:
obtain prescription information,
obtain a medication schedule based on the prescription information,
receive via the communication module at least one prescribed medicine image corresponding to at least one prescribed medicine from a first external device, and
control the output module to display the at least one prescribed medicine image when a medication time according to the medication schedule occurs,
wherein the at least one prescribed medicine is determined based on the prescription information.

2. The apparatus of claim 1, wherein the controller is configured to receive via the communication module an electronic prescription from a second external device, and to obtain the prescription information based on the received electronic prescription.

3. The apparatus of claim 1, further comprising:
a camera configured to capture an image of a paper prescription containing the prescription information,
wherein the controller is configured to obtain the prescription information based on the captured image.

4. The apparatus of claim 1, further comprising:
a camera configured to capture an image of an identification code containing the prescription information,
wherein the controller is configured to obtain the prescription information based on the captured image.

5. The apparatus of claim 1, wherein, when the medication time occurs, the controller is configured to control the output module to output a medication notification message.

6. The apparatus of claim 1, further comprising:
an input module,
wherein the controller is configured to receive via the input module a signal indicating a selection of a medicine image from the displayed at least one prescribed medicine image, and to determine whether a medicine from the at least one prescribed medicine corresponding to the selected medicine image was taken based on the signal.

7. The apparatus of claim 6, further comprising:
a storage unit,
wherein the controller is configured to store a medication status on the medication schedule, the medication status indicating whether the medicine from the at least one prescribed medicine corresponding to the selected medicine image was taken based on the signal.

8. The apparatus of claim 7, wherein the controller is configured to transmit via the communication module information indicating whether the medicine was taken to the first external device.

9. The apparatus of claim 1, further comprising:
an input module,
wherein the controller is configured to receive via the input module a signal for selecting a medicine image from the displayed at least one prescribed medicine image, and to control the output module to display supplementary information of a medicine corresponding to the selected medicine image.

10. The apparatus of claim 9, wherein the supplementary information of the medicine includes at least one of a name of the medicine, an effect of the medicine, directions for taking the medicine, a price of the medicine, a period of circulation of the medicine, a disease treated by the medicine, a note of caution associated with taking the medicine, a different medicine that should not be taken in conjunction with the taking of the medicine, and a food that should be avoided in conjunction with the taking of the medicine.

11. A system for medication management comprising:
an apparatus for medication management, the apparatus including:
an output module;
a communication module; and
a controller configured to:
obtain prescription information,
obtain a medication schedule based on the prescription information,
receive, via the communication module, at least one prescribed medicine image corresponding to at least one prescribed medicine, and
control the output module to display the at least one prescribed medicine image when a medication time according to the medication schedule occurs,
wherein the at least one prescribed medicine is determined based on the prescription information; and
a first external device storing the at least one prescribed medicine image,
wherein the controller receives via the communication module the at least one prescribed medicine image from the first external device

12. The system of claim 11, wherein the first external device is configured to:
store a plurality of medicine images,
select the at least one prescribed medicine image corresponding to the at least one prescribed medicine from the plurality of medicine images based on the prescription information, and
transmit the selected at least one prescribed medicine image to the apparatus for a medication management.

13. The system of claim 11, further comprising:
a second external device,
wherein the controller is configured to receive via the communication module an electronic prescription from a second external device, and to obtain the prescription information based on the received electronic prescription.

14. A method for medication management, the method performed by an electronic device, the method comprising:
obtaining, by the electronic device, prescription information;
obtaining at least one prescribed medicine and a medication schedule based on the prescription information;
transmitting information identifying the at least one prescribed medicine to a first external device;
receiving at least one prescribed medicine image corresponding to the at least one prescribed medicine from the first external device; and
displaying, by the electronic device, the at least one prescribed medicine image when a medication time according to a medication schedule occurs.

15. The method of claim 14, further comprising:
receiving an electronic prescription from a second external device; and
obtaining the prescription information based on the received electronic prescription.

16. The method of claim 14, further comprising:
capturing an image of a paper prescription containing the prescription information; and
obtaining the prescription information based on the captured image.

17. The method of claim 14, further comprising:
capturing an image of an identification code containing the prescription information; and
obtaining the prescription information based on the captured image.

18. The method of claim 14, further comprising:
receiving a signal for selecting a medicine image from the displayed at least one prescribed medicine image; and
determining whether medicine corresponding to the selected medicine image is taken at the medication time based on the received signal.

19. The method of claim 18, further comprising storing a medication status on the medication schedule, the medication status indicating whether the medicine from the at least one prescribed medicine corresponding to the selected medicine image was taken based on the received signal.

20. The method of claim 19, further comprising transmitting information indicating whether the medicine was taken to the first external device.
